(19) United States
(12) Patent Application Publication
(10) Pub. No.: US 2021/0365945 A1
(43) Pub. Date: Nov. 25, 2021

(54) Automatic User Identification and Authentication System

(71) Applicant: BANK OF AMERICA CORPORATION, Charlotte, NC (US)

(72) Inventor: Vijay Kumar Yarabolu, Hyderabad (IN)

(21) Appl. No.: 16/880,094

(22) Filed: May 21, 2020

(51) Int. Cl. G06Q 20/40; G06Q 20/34

(52) U.S. Cl. CPC G06Q 20/4014; G06Q 20/34

(57) ABSTRACT

A system strengthens the identification and authentication process by bringing in additional information about the user that was previously unused. The merchant in the system first provides a pre-authentication token generated using the information provided through the user's payment card. If a processing server and/or identification server validate that information, the pre-authentication token is communicated back to the merchant. The merchant then initiates a pre-authentication session and provides in that session information about the user in the merchant's possession (e.g., information gleaned from security camera footage like apparent age, height, gender, license plate number, hairstyle, etc.) The pre-authentication session is then communicated to the processing server and/or identification server to be used to further identify and authenticate the user.

### TECHNICAL FIELD

This disclosure relates generally to user identification and authentication.

### BACKGROUND

Users usually proceed through an identification and authentication process when conducting transactions at physical terminals.

### SUMMARY OF THE DISCLOSURE

Users usually proceed through an identification and authentication process when conducting transactions at physical terminals. For example, when a user presents a payment card (e.g., credit/debit card) to buy items at a physical store, the card is swiped or scanned and then the merchant proceeds through an identification and authentication process that is transparent to the user. If the identification and authentication process is successful, the user is allowed to make the purchase.

Typically, the information used to identify and authenticate the user is stored with the user's payment card. For example, swiping or scanning the card may provide access to the user's name and unique card number. This information is then used to identify and authenticate the user. This information, however, does not present a full picture of the user and is generally unreliable in identifying or authenticating the user with a high degree of certainty. Additionally, there exists a large amount of information in the merchant's possession (e.g., security video footage, pictures, etc.) that would be useful in strengthening the identification and authentication, but this information is typically not used to identify or authenticate the user.

This disclosure contemplates a system that strengthens the identification and authentication process by bringing in additional information about the user that was previously unused. The merchant in the system first provides a pre-authentication token generated using the information provided through the user's payment card. If a processing server and/or identification server validate that information, the pre-authentication token is communicated back to the merchant. The merchant then initiates a pre-authentication session and provides, in that session, information about the user in the merchant's possession (e.g., information gleaned from security camera footage like apparent age, height, gender, license plate number, hairstyle, etc.) The pre-authentication session is then communicated to the processing server and/or identification server to be used to further identify and authenticate the user. In this manner, information that was previously unused is used to identify and authenticate the user. In particular embodiments, the identification and authentication of the user is more reliable and has a higher degree of certainty when the additional information is used. Certain embodiments are described below.

According to an embodiment, a system includes a merchant terminal, a processing server, and an identification server. The merchant terminal receives, from a customer, information from the customer's payment card for a purchase, generates a pre-authentication token using the information from the customer's payment card, and communicates the pre-authentication token to the processing server. The processing server communicates the pre-authentication token to the merchant terminal if the information from the customer's payment card is validated. The merchant terminal generates a pre-authentication session in response to receiving the pre-authentication token from the processing server, adds information about the customer taken at the time of the purchase to the pre-authentication session, and communicates the pre-authentication session to the processing server. The processing server communicates the pre-authentication session to the identification server. The identification server compares the information about the customer taken at the time of the purchase with information about the customer provided at the time the customer applied for the payment card to generate an identification score and compares the identification score to a threshold. If the identification scores exceeds the threshold, the identification server approves the purchase. If the identification score does not exceed the threshold, the identification server denies the purchase.

According to another embodiment, a method includes receiving, by a merchant terminal and from a customer, information from the customer's payment card for a purchase, generating, by the merchant terminal, a pre-authentication token using the information from the customer's payment card, and communicating, by the merchant terminal, the pre-authentication token to a processing server. The method also includes communicating, by the processing server, the pre-authentication token to the merchant terminal if the information from the customer's payment card is validated, generating, by the merchant terminal, a pre-authentication session in response to receiving the pre-authentication token from the processing server, and adding, by the merchant terminal, information about the customer taken at the time of the purchase to the pre-authentication session. The method further includes communicating, by the merchant terminal, the pre-authentication session to the processing server, communicating, by the processing server, the pre-authentication session to an identification server, comparing, by the identification server, the information about the customer taken at the time of the purchase with information about the customer provided at the time the customer applied for the payment card to generate an identification score, and comparing, by the identification server, the identification score to a threshold. The method further includes, if the identification scores exceeds the threshold, approving, by the identification server, the purchase, and if the identification score does not exceed the threshold, denying, by the identification server, the purchase.

According to another embodiment, an apparatus includes a memory and a hardware processor communicatively coupled to the memory. The hardware processor receives, from a processing server, a pre-authentication session indicating information about a customer taken at a time of a purchase and information about the customer provided at a time the customer applied for a payment card used during a purchase at a merchant terminal. The merchant terminal generates a pre-authentication token using the information from the payment card and communicates the pre-authentication token to the processing server. The processing server communicates the pre-authentication token to the merchant terminal if the information from the customer's payment card is validated. The merchant terminal further generates the pre-authentication session in response to receiving the pre-authentication token from the processing server. The hardware processor also compares the information about the customer taken at the time of the purchase with information about the customer provided at the time the customer applied for the payment card to generate an identification score and compares the identification score to a threshold. If the identification scores exceeds the threshold, the hardware processor approves the purchase. If the identification score does not exceed the threshold, the hardware processor denies the purchase.

Certain embodiments provide one or more technical advantages. For example, an embodiment provides a more reliable identification and authentication of a user. As another example, an embodiment uses information that was previously unused to improve the identification and authentication of a user. Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1 illustrates an example system;

FIG. 2 illustrates an example operation of the system of FIG. 1; and

FIG. 3 is a flowchart illustrating a method for operating an identification server of the system of FIG. 1.

### DETAILED DESCRIPTION

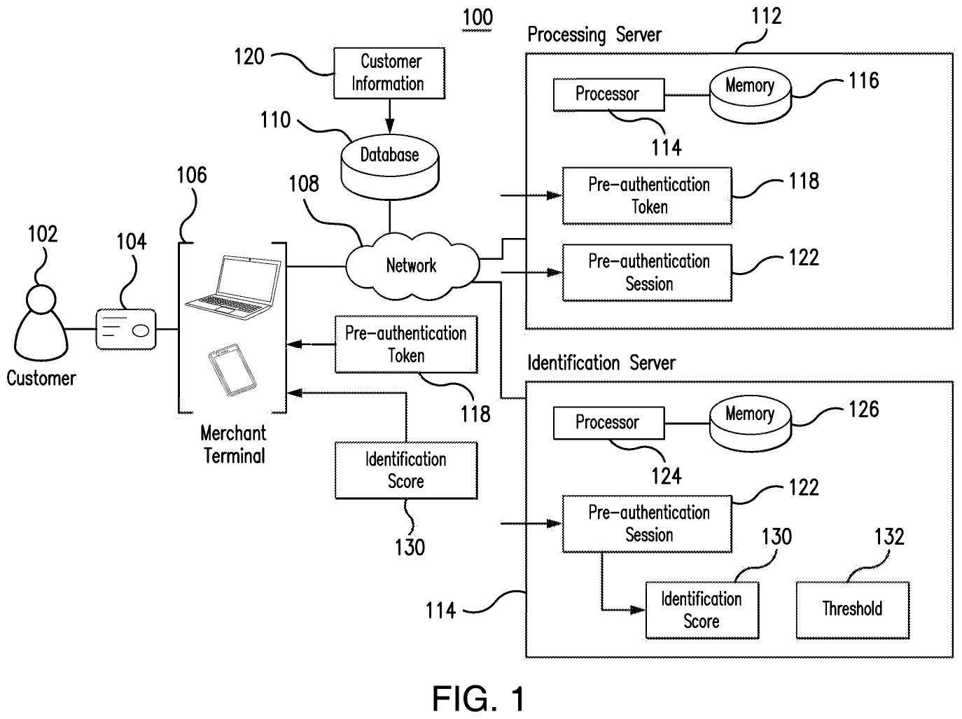

Embodiments of the present disclosure and its advantages are best understood by referring to FIGS. 1 through 3 of the drawings, like numerals being used for like and corresponding parts of the various drawings.

Users usually proceed through an identification and authentication process when conducting transactions at physical terminals. For example, when a user presents a payment card (e.g., credit/debit card) to buy items at a physical store, the card is swiped or scanned and then the merchant proceeds through an identification and authentication process that is transparent to the user. If the identification and authentication process is successful, the user is allowed to make the purchase.

Typically, the information used to identify and authenticate the user is stored with the user's payment card. For example, swiping or scanning the card may provide access to the user's name and unique card number. This information is then used to identify and authenticate the user. This information, however, does not present a full picture of the user and is generally unreliable in identifying or authenticating the user with a high degree of certainty. Additionally, there exists a large amount of information in the merchant's possession (e.g., security video footage, pictures, etc.) that would be useful in strengthening the identification and authentication, but this information is typically not used to identify or authenticate the user resulting in information waste.

This disclosure contemplates a system that strengthens the identification and authentication process by bringing in additional information about the user that was previously unused. The merchant in the system first provides a pre-authentication token generated using the information provided through the user's payment card. If a processing server and/or identification server validate that information, the pre-authentication token is communicated back to the merchant. The merchant then initiates a pre-authentication session and provides, in that session, information about the user in the merchant's possession (e.g., information gleaned from security camera footage like apparent age, height, gender, license plate number, hairstyle, etc.) The pre-authentication session is then communicated to the processing server and/or identification server to be used to further identify and authenticate the user. In this manner, information that was previously unused is used to identify and authenticate the user, thereby reducing information waste. In particular embodiments, the identification and authentication of the user is more reliable and has a higher degree of certainty when the additional information is used.

The system thus provides a practical application in that the system provides a more reliable identification and authentication of a user. Additionally, the system uses previously unused information to improve the identification and authentication of the user. The system will be described in more detail using FIGS. 1 through 3.

FIG. 1 illustrates an example system 100. As seen in FIG. 1, system 100 includes one or more merchant terminals 106, a network 108, a database 110, a processing server 112, and an identification server 114. Generally, processing server 112 and identification server 114 perform an identification and authentication process with merchant terminal 106. In particular, embodiments, this process uses additional information of the merchant that was not previously used to identify and authenticate customer 102, thereby reducing information waste and improving the reliability of the identification and authentication.

Customer 102 makes purchases at merchant terminal 106. Customer 102 may present a payment card 104 to merchant terminal 106 to make the purchase. Payment card 104 may be any suitable card presented by customer 102 to initiate and complete a purchase, such as for example, a credit or debit card. Payment card 104 may include information that is used to identify and authenticate customer 102. For example, payment card 104 may include a name of customer 102 and/or a unique card number. In conventional processes, once this information is used to identify and authenticate customer 102, the purchase is granted. However, an identification and authentication based on this information may not be very reliable. For example, the information on the card is static and does not indicate whether customer 102 is the customer identified by the information on payment card 104. To improve the identification and authentication process, system 100 uses additional information in the possession of the merchant to identify and authenticate customer 102. In this manner, information that was previously unused to identify and authenticate customer 102 is used thereby reducing information waste. Additionally, using this information provides a more reliable identification and authentication of customer 102.

Merchant terminal 106 may be any suitable device for initiating a transaction. For example, merchant terminal 106 may be a cash register, a tablet, a phone, a laptop, a personal computer, a payment terminal, a kiosk, etc. Merchant terminal 106 receives information from customer 102 and/or payment card 104 when a purchase is requested. Merchant terminal 106 then initiates the identification and authentication process. If customer 102 is successfully identified and authentication, merchant terminal 106 may proceed with the requested purchase. If customer 102 is not successfully identified and/or authenticated, merchant terminal 106 may deny the requested purchase.

Merchant terminal 106 includes any appropriate device for communicating with components of system 100 over network 108. For example, merchant terminal 106 may be a telephone, a mobile phone, a computer, a laptop, a tablet, an automated assistant, and/or a cash register. This disclosure contemplates merchant terminal 106 being any appropriate device for sending and receiving communications over network 108. As an example and not by way of limitation, merchant terminal 106 may be a computer, a laptop, a wireless or cellular telephone, an electronic notebook, a personal digital assistant, a tablet, or any other device capable of receiving, processing, storing, and/or communicating information with other components of system 100. Merchant terminal 106 may also include a user interface, such as a display, a microphone, keypad, or other appropriate terminal equipment usable by customer 102. In some embodiments, an application executed by merchant terminal 106 may perform the functions described herein.

Network 108 allows communication between and amongst the various components of system 100. This disclosure contemplates network 108 being any suitable network operable to facilitate communication between the components of system 100. Network 108 may include any interconnecting system capable of transmitting audio, video, signals, data, messages, or any combination of the preceding. Network 108 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Database 110 stores information in the possession of the merchant of the merchant terminal 106 including customer information 120. Database 110 may store any suitable information about the merchant or customer 102. For example, database 110 may store customer information 120 that incudes security video footage of customer 102 in or around a physical store of the merchant. Customer information 120 may include features of customer 102 that can be extracted from the security footage such as, for example, the customer's gender, height, hairstyle, apparent age, license plate number, etc. The merchant my store this customer information 120 in database 110 for future records. In a conventional identification and authentication process, this information may not be used or sent to other components of system 100 such as, for example, processing server 112 and/or identification server 114. However, in system 100, other components of system 100 use this customer information 120 to identify and authenticate customer 102. As a result, customer information 120 is put to further use and is not wasted. As a result, the identification and authentication process is made more reliable.

Processing server 112 generally performs a pre-authentication of customer 102. Processing server 112 may be implemented by an entity that handles the merchant's transactions (e.g., a merchant's bank or vendor). For example, processing server 112 may be associated with a payment processor of the merchant. This payment processor may validate information provided by merchant terminal 106 to determine whether a requested purchase should be granted or denied. As seen in FIG. 1, processing server 112 includes a processor 114 and a memory 116. Processor 114 and memory 116 may be configured to perform any of the functions of processing server 112 discussed herein.

Processor 114 is any electronic circuitry, including, but not limited to microprocessors, application specific integrated circuits (ASIC), application specific instruction set processor (ASIP), and/or state machines, that communicatively couples to memory 116 and controls the operation of processing server 112. Processor 114 may be 8-bit, 16-bit, 32-bit, 64-bit or of any other suitable architecture. Processor 114 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. Processor 114 may include other hardware that operates software to control and process information. Processor 114 executes software stored on memory to perform any of the functions described herein. Processor 114 controls the operation and administration of processing server 112 by processing information received from merchant terminal 106, network 108, and memory 116. Processor 114 may be a programmable logic device, a microcontroller, a microprocessor, any suitable processing device, or any suitable combination of the preceding. Processor 114 is not limited to a single processing device and may encompass multiple processing devices.

Memory 116 may store, either permanently or temporarily, data, operational software, or other information for processor 114. Memory 116 may include any one or a combination of volatile or non-volatile local or remote devices suitable for storing information. For example, memory 116 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in memory 116, a disk, a CD, or a flash drive. In particular embodiments, the software may include an application executable by processor 114 to perform one or more of the functions described herein.

When customer 102 presents payment card 104 to merchant terminal 106, merchant terminal 106 extracts information from payment card 104 such as, for example, a name of customer 102 and a card number of payment card 104. Merchant terminal 106 then generates a pre-authentication token 118 that encapsulates the information extracted from payment card 104. Merchant terminal 106 communicates pre-authentication token 118 to processing server 112 to identify and authenticate customer 102. Processing server 112 receives pre-authentication token 118 and extracts the encapsulated information. Processing server 112 then verifies and validates the information encapsulated in pre-authentication token 118 to perform an initial identification and authentication of customer 102. If the information encapsulated in pre-authentication token 118 is correct, processing server 112 may communicate pre-authentication token 118 back to merchant terminal 106. When merchant terminal 106 receives pre-authentication token 118 from processing server 112, merchant terminal 106 may determine that the pre-authentication process was successful. If merchant terminal 106 does not receive pre-authentication token 118 from processing server 112, merchant terminal 106 may determine that the pre-authentication process failed and deny the purchase requested by customer 102. In certain embodiments, during the pre-authentication process, processing server 112 may consider any suitable information such as the geographic location of merchant terminal 106 and/or payment card 104, the time of day, and an available balance linked to payment card 104.

In particular embodiments, identification server 114 may perform a portion of the pre-authentication process. For example, processing server 112 may communicate some of the information encapsulated in pre-authentication token 118 to identification server 114. Identification server 114 may then validate or verify the information provided by processing server 112. Identification server 114 may then communicate back to processing server 112 whether the information is valid. For example, identification server 114 may communicate pre-authentication token 118 back to processing server 112 to indicate that the information is valid and/or verified. If identification server 114 does not communicate pre-authentication token 118 back to processing server 112, processing server 112 may determine that the pre-authentication process failed.

Identification server 114 may belong to an issuer of payment card 104. As a result, identification 114 may have access to personal information of customer 102 (e.g., information provided by customer 102 when applying for card 104). Identification server 114 may use that information to verify and/or validate the identity of customer 102. As seen in FIG. 1, identification server 114 includes a processor 124 and a memory 126. Processor 124 and memory 126 may be configured to perform any of the functions of identification server 114 discussed herein. In particular embodiments, identification server 114 uses additional information provided by the merchant to improve the reliability of the identification and authentication process.

Processor 124 is any electronic circuitry, including, but not limited to microprocessors, application specific integrated circuits (ASIC), application specific instruction set processor (ASIP), and/or state machines, that communicatively couples to memory 126 and controls the operation of identification server 114. Processor 124 may be 8-bit, 16-bit, 32-bit, 64-bit or of any other suitable architecture. Processor 124 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. Processor 124 may include other hardware that operates software to control and process information. Processor 124 executes software stored on memory to perform any of the functions described herein. Processor 124 controls the operation and administration of identification server 114 by processing information received from merchant terminal 106, network 108, and memory 126. Processor 124 may be a programmable logic device, a microcontroller, a microprocessor, any suitable processing device, or any suitable combination of the preceding. Processor 124 is not limited to a single processing device and may encompass multiple processing devices.

Memory 126 may store, either permanently or temporarily, data, operational software, or other information for processor 124. Memory 126 may include any one or a combination of volatile or non-volatile local or remote devices suitable for storing information. For example, memory 126 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in memory 126, a disk, a CD, or a flash drive. In particular embodiments, the software may include an application executable by processor 124 to perform one or more of the functions described herein.

After merchant terminal 106 receives pre-authentication token 118 from processing server 112, merchant terminal 106 may perform another identification process using customer information 120 to improve the identification and authentication of customer 102. Merchant terminal 106 may generate a pre-authentication session 122 and communicate pre-authentication session 122 to processing server 112. Pre-authentication session 122 may include customer information 120. Customer information 120 may include any suitable information that the merchant owns about customer 102, such as for example, name, age, height, hairstyle, gender, license plate number, etc. Customer information 120 may be extracted from the merchant's security video footage of customer 102. For example, customer information 120 may be extracted from a security video of customer 102 at merchant terminal 106. As another example, customer information 120 may be extracted from security video of customer 102 parked in a parking lot of the merchant.

Processing server 112 may receive pre-authentication session 122 and customer information 120. Processing server 112 may then communicate pre-authentication session 122 and customer information 120 to identification server 114 for verification and validation. Because identification sever 114 belongs to an issuer of payment card 104, identification server 114 may have more personal information about customer 102 such as, for example, age, height, license plate number, etc. Identification server 114 compares customer information 120 with the information provided by customer 102 such as, for example, when customer 102 applied for payment card 104 to verify and validate customer information 120.

Identification server 114 generates an identification score 130 based on the comparison. Identification score 130 indicates a likelihood that customer 102 is the appropriate owner of payment card 104. For example, the more customer information 120 (e.g., age, height, gender, hairstyle, license plate number, etc.) match the information for customer 102 that identification server 114 maintains, the higher identification score 130 may be. Identification server 114 compares identifications score 130 to threshold 132. If identification score 130 exceeds threshold 132, identification server 114 may determine that customer information 120 is valid and verified. If identification score 130 falls below threshold 132, identification server 114 may determine that customer information is invalid and not verified. In certain embodiments, if identification score 130 exceeds threshold 132, the requested purchase is granted. If identification score 130 does not exceed threshold 132, the purchase is rejected.

In certain embodiments, identification server 114 may communicate identification score 130 to merchant terminal 106 so that merchant terminal 106 may evaluate whether to grant or deny the requested purchase. In certain embodiments, merchant terminal 106 may further determine what appropriate actions to take in response to identification score 130. For example, if identification score 130 is exceptionally low, merchant terminal 106 may notify the authorities to come investigate customer 102.

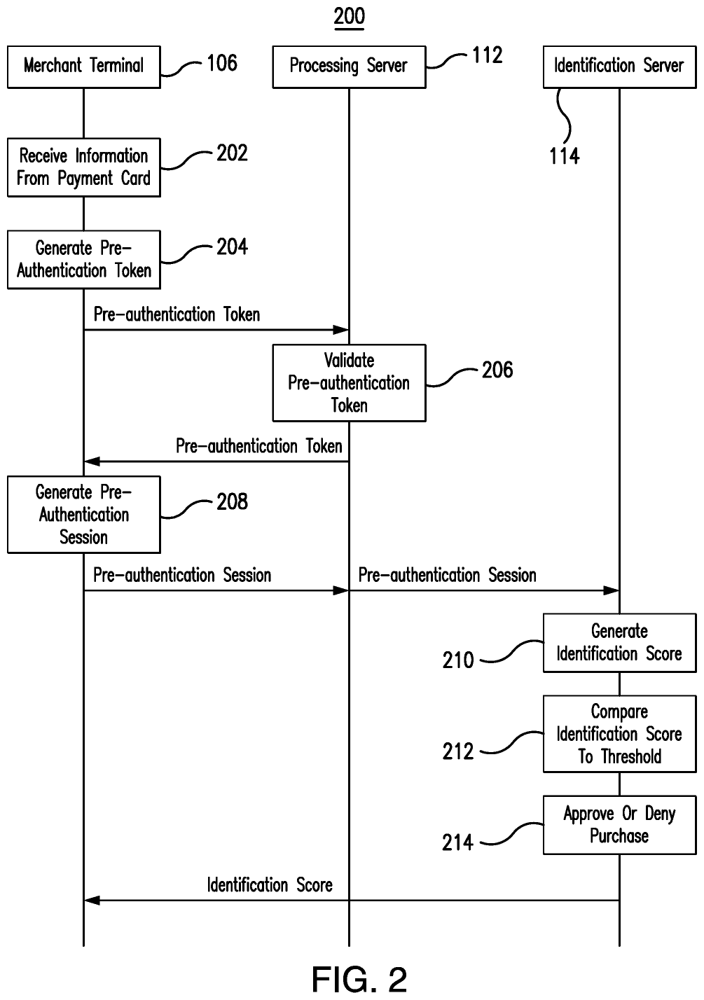

FIG. 2 illustrates an example operation of the system 100 of FIG. 1 according to a method 200. Generally, one or more components of system 100 such as merchant terminal 106, processing server 112, and identification server 114 perform one or more steps of method 200. In particular embodiments, by performing method 200, customer information that was previously unused is used to identify and authenticate a customer 102, thereby reducing information waste. Additionally, using this customer information 120 improves the reliability of the identification and authentication.

Merchant terminal 106 receives information from payment card 104 in step 202. The information may include a name of customer 102 and/or a card number on payment card 104. The information may be received because customer 102 is requesting a purchase from merchant terminal 106 and is presenting payment card 104 for payment. In step 204, merchant terminal 106 generates pre-authentication token 118. Pre-authentication token 118 may encapsulate the information received from payment card 104. Merchant terminal 106 communicates pre-authentication token 118 to processing server 112.

Processing server 112 validates pre-authentication token 118 in step 206. Processing server 112 may validate pre-authentication token 118 by analyzing the information encapsulated in pre-authentication token 118. For example, processing server 112 may validate the name and card number from payment card 104. In some embodiments, processing server 112 may analyze the location of merchant terminal 106 and/or payment card 104 to verify pre-authentication token 118. If processing server 112 validates pre-authentication token 118, processing server 112 communicates pre-authentication token 118 back to merchant terminal 106. If processing server 112 does not validate or verify pre-authentication token 118, processing server 112 may not communicate pre-authentication token 118 back to merchant terminal 106.

If merchant terminal 106 receives pre-authentication token 118 from processing server 112, merchant terminal 106 continues with the identification and authentication process by generation a pre-authentication session 122 in step 208. Merchant terminal 106 may add customer information 120 into pre-authentication session 122. Customer information 120 may include information owned and controlled by the merchant such as, for example, security video footage of customer 102 and information extracted from the security footage such as, for example, a hair color, hairstyle, a height, an age, a gender, and/or a license plate number of customer 102. Merchant terminal 106 then communicates pre-authentication session 122 to processing server 112. Processing server 112 may then communicate pre-authentication session 122 to identification server 114.

Identification server 114 verifies the information in pre-authentication session 122 to identify and authenticate customer 102. Identification server 114 may belong to an issuer of payment card 104 so identification server 114 may have access to more personal information about customer 102. Identification server 114 compares customer information 120 and/or pre-authentication session 122 with the information provided by customer 102 when customer 102 applied for payment card 104 to identify or authenticate customer 102. In step 210, identification server 114 generates an identification score 130 based on comparing the customer information 120 and/or pre-authentication session 122 with the information provided by customer 102. Identification server 114 then compares identification score 130 to a threshold 132 in step 212. Identification server 114 then approves or denies the requested purchase in step 214 based on the comparison of identification score 130 to threshold 132. In certain embodiments, identification server 114 may further communicate identification score 130 back to merchant terminal 106 so that merchant terminal 106 can evaluate identification score 130 and take appropriate action such as, for example, notifying authorities or security.

Merchant terminal 106 may accept or reject a purchased based on whether identification score 130 exceeds threshold 132. If identification score 130 does not exceed threshold 132, merchant terminal 106 may reject the purchase. If identification score 130 exceeds threshold 132, merchant terminal 106 may accept the purchase. Identification server 114 may notify merchant terminal 106 about whether to accept or reject the purchase in any suitable manner. For example, identification server 114 may communicate the pre-authentication session 122 back to merchant terminal 106 (e.g., via processing server 112) if identification score 130 exceeds threshold 132. If merchant terminal 106 receives pre-authentication session 122 from identification server 114, merchant terminal 106 accepts the purchase, otherwise, merchant terminal 106 rejects the purchase.

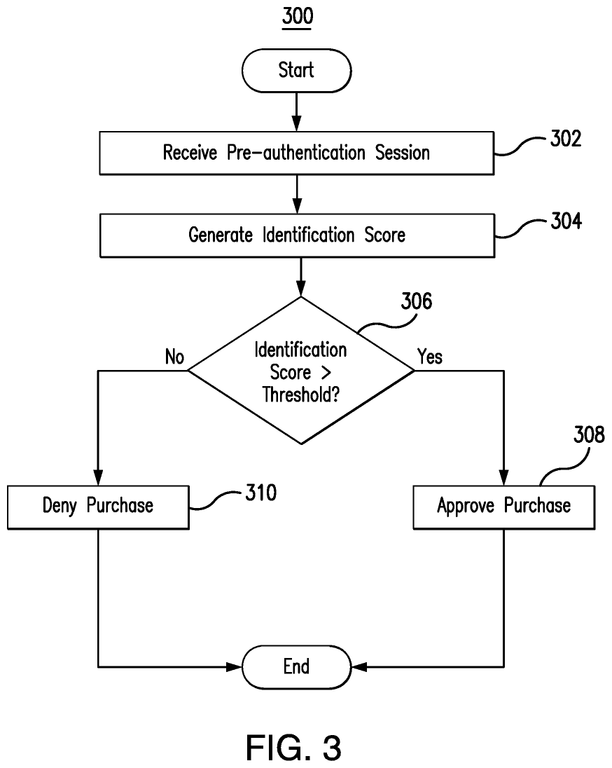

FIG. 3 is a flowchart illustrating a method 300 for operating an identification server 114 of the system 100 of FIG. 1. In particular embodiments, identification server 114 performs the steps of method 300. By performing method 300, identification server 114 reduces information waste and improves the reliability of identification and authentication.

Identification server 114 begins by receiving a pre-authentication session 122 in step 302. Pre-authentication session 122 may include customer information 120 extracted from information held or owned by a merchant. Customer information 120 may include information extracted from security video footage of customer 102. In step 304, identification server 114 generates an identification score 130. Identification server 114 may generate identification score 130 by comparing the customer information 120 in pre-authentication session 122 with information provided by customer 102 when customer 102 applied for payment card 104. This information may include personal information such as age, gender, and/or license plate number. Identification score 130 may indicate a likelihood that customer 102 is the same customer who applied for payment card 104.

Identification server 114 compares identification score 130 to a threshold 132 in step 306. If the identification score 130 exceeds threshold 132, identification server 114 approves a purchase in step 308. If identification score 130 does not exceed threshold 132, identification server 114 denies the purchase in step 310.

Modifications, additions, or omissions may be made to method 300 depicted in FIG. 3. Method 300 may include more, fewer, or other steps. For example, steps may be performed in parallel or in any suitable order. While discussed as identification server 114 performing the steps, any suitable component of system 100, such as merchant terminal 106 and processing server 112 for example, may perform one or more steps of the methods.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

1. A system comprising:
a merchant terminal;
a database configured to store customer information that comprises a security video footage of a customer captured by a security camera, wherein the security video footage is captured at a location different from where the merchant terminal is located;
a processing server; and
an identification server, the merchant terminal configured to:
receive, from the customer, information from the customer's payment card for a purchase;
generate a pre-authentication token using the information from the customer's payment card; and
communicate the pre-authentication token to the processing server;
the processing server configured to communicate the pre-authentication token to the merchant terminal if the information from the customer's payment card is validated;
the merchant terminal further configured to:
generate a pre-authentication session in response to receiving the pre-authentication token from the processing server;
access the security video footage of the customer from the database;
add information about the customer to the pre-authentication session, wherein the information comprises the security video footage; and
communicate the pre-authentication session to the processing server;
the processing server further configured to communicate the pre-authentication session to the identification server; and
the identification server configured to:
extract, from the security video footage, a set of features associated with the customer;
compare the extracted set of features with information about the customer provided at the time the customer applied for the payment card to generate an identification score;
compare the identification score to a threshold;
if the identification score exceeds the threshold, validate the identity of the customer; and
if the identification score does not exceed the threshold, determine that the identity of the customer is not validated.

2. (canceled)

3. The system of claim 1, wherein the extracted set of features comprises at least one of an age of the customer, a gender of the customer, and a license plate number of the customer.

4. The system of claim 1, wherein the information from the customer's payment card comprises at least one of a name of the customer and a card number of the payment card.

5. The system of claim 1, wherein the merchant terminal is further configured to determine that the identity of the customer is not validated if the processing server does not communicate the pre-authentication token to the merchant terminal.

6. The system of claim 1, wherein the pre-authentication token was generated using a location of the merchant terminal.

7. The system of claim 1, wherein the identification server is further configured to communicate the identification score to the merchant terminal.

8. A method comprising:
receiving, by a merchant terminal and from a customer, information from the customer's payment card for a purchase;
generating, by the merchant terminal, a pre-authentication token using the information from the customer's payment card;
communicating, by the merchant terminal, the pre-authentication token to a processing server;
communicating, by the processing server, the pre-authentication token to the merchant terminal if the information from the customer's payment card is validated;
generating, by the merchant terminal, a pre-authentication session in response to receiving the pre-authentication token from the processing server;
accessing a security video footage of the customer from a database, wherein the security video footage is captured at a location different from where the merchant terminal is located;
adding, by the merchant terminal, information about the customer to the pre-authentication session, wherein the information comprises the security video footage;
communicating, by the merchant terminal, the pre-authentication session to the processing server;
communicating, by the processing server, the pre-authentication session to an identification server;
extracting, from the security video footage, a set of features associated with the customer;
comparing, by the identification server, the extracted set of features with information about the customer provided at the time the customer applied for the payment card to generate an identification score;
comparing, by the identification server, the identification score to a threshold;
if the identification score exceeds the threshold, validating, by the identification server, the identity of the customer; and
if the identification score does not exceed the threshold, determining, by the identification server, that the identity of the customer is not validated.

9. (canceled)

10. The method of claim 8, wherein the extracted set of features comprises at least one of an age of the customer, a gender of the customer, and a license plate number of the customer.

11. The method of claim 8, wherein the information from the customer's payment card comprises at least one of a name of the customer and a card number of the payment card.

12. The method of claim 8, further comprising determining, by the merchant terminal, that the identity of the customer is not validated if the processing server does not communicate the pre-authentication token to the merchant terminal.

13. The method of claim 8, wherein the pre-authentication token was generated using a location of the merchant terminal.

14. The method of claim 8, further comprising communicating, by the identification server, the identification score to the merchant terminal.

15. An apparatus comprising:
a memory; and
a hardware processor communicatively coupled to the memory, the hardware processor configured to:
receive, from a processing server, a pre-authentication session indicating information about a customer and information about the customer provided at a time the customer applied for a payment card used during a purchase at a merchant terminal, the merchant terminal configured to generate a pre-authentication token using the information from the payment card and to communicate the pre-authentication token to the processing server, the processing server configured to access a security video footage of the customer captured by a security camera, wherein the security video footage is captured at a location different from where the merchant terminal is located, add the security video footage to the pre-authentication session, and communicate the pre-authentication token to the merchant terminal if the information from the customer's payment card is validated, the merchant terminal further configured to generate the pre-authentication session in response to receiving the pre-authentication token from the processing server;
extract, from the security video footage, a set of features associated with the customer;
compare the extracted set of features with information about the customer provided at the time the customer applied for the payment card to generate an identification score;
compare the identification score to a threshold;
if the identification score exceeds the threshold, validate the identity of the customer; and
if the identification score does not exceed the threshold, determine that the identity of the customer is not validated.

16. (canceled)

17. The apparatus of claim 15, wherein the extracted set of features comprises at least one of an age of the customer, a gender of the customer, and a license plate number of the customer.

18. The apparatus of claim 15, wherein the information from the customer's payment card comprises at least one of a name of the customer and a card number of the payment card.

19. The apparatus of claim 15, wherein the merchant terminal is further configured to determine that the identity of the customer is not validated if the processing server does not communicate the pre-authentication token to the merchant terminal.

20. The apparatus of claim 15, wherein the pre-authentication token was generated using a location of the merchant terminal.
